(19) United States
(12) Patent Application Publication
(10) Pub. No.: US 2016/0165391 A1
(43) Pub. Date: Jun. 9, 2016

(54) System and processes to facilitate context-based messaging

(71) Applicants: Ryan Hedley Turner, Austin, TX (US); Daniel Steven Haligas, Panama City, FL (US); Velayudhan Venugopal, Austin, TX (US); Alex Holm Devine, Austin, TX (US); Juliette Susan Kimes, Dripping Springs, TX (US)

(72) Inventors: Ryan Hedley Turner, Austin, TX (US); Daniel Steven Haligas, Panama City, FL (US); Velayudhan Venugopal, Austin, TX (US); Alex Holm Devine, Austin, TX (US); Juliette Susan Kimes, Dripping Springs, TX (US)

(73) Assignee: HomeAway, Inc., Austin, TX (US)

(21) Appl. No.: 14/544,207

(22) Filed: Dec. 8, 2014

(51) Int. Cl. H04W 4/02; H04W 64/00; H04W 4/12

(52) U.S. Cl. CPC H04W 4/021; H04W 4/12; H04W 64/006

(57) ABSTRACT

A process, a system or both may be configured to correlate triggers indicative of an occurrence of one or more events or other data associated with lodging for a traveler, determine if one or more precedent conditions associated with the one or more events are satisfied, and generate one or more context-specific messages when the one or more precedent conditions have been satisfied. Context-specific messages may be communicated (e.g. wirelessly) to a client computing device (e.g., a smartphone, tablet or pad) pursuant to one or more precedent conditions being satisfied. The context-specific message(s) and at least one of the one or more precedent conditions may originate from a member computing device (e.g., a computing device of an owner or a proprietor). Geolocation based data included in one or more triggers may be used to activate communication of the context-specific message(s) and/or to satisfy one or more precedent conditions.

### CROSS-REFERENCE TO RELATED APPLICATIONS

This application is related to U.S. patent application Ser. No. 14/539,970, filed on Nov. 12, 2014, having Attorney Docket No. HOM-152, and titled “Systems And Methods To Modify Direction Of Travel As A Function Of Action Items”, and is related to U.S. patent application Ser. No. 14/562,629, filed on Dec. 5, 2014, having Attorney Docket No. HOM-156, and titled “Adaptive Advisory Engine And Methods To Predict Preferential Activities Available At A Region Associated With Lodging” all of which are herein incorporated by reference in their entirety for all purposes.

### FIELD

The present application relates generally to systems, software, electronic messaging, mobile computing and communication devices. More specifically, systems, applications, computing devices and methods to facilitate context-based messaging associated with lodging.

### BACKGROUND

Information relevant to a stay at lodging (e.g., a rental, a vacation rental) may helpful to a user (e.g., a traveler, customer, client, member) at different time periods during the stay, such as before the stay begins, during the stay, and after the stay has ended. Moreover, change occurring during the different time periods may affect the information and its relevancy to the user. As one example, if the user is traveling to the lodging, then weather conditions may affect the information the user may find relevant for travel to the lodging, such as alternate routes to travel to avoid or mitigate the effects of the weather. Activities the user planned to partake in during the stay may be cancelled and/or affected by changes in weather. The user may not be aware of information on activities available in a region around the lodging that may be of interest to the user.

Thus, there is a need for devices, systems and methods that access information associated with a stay in a geographic region that includes lodging and process the information to generate context-specific messages tailored to different periods of a stay at the lodging.

### BRIEF DESCRIPTION OF THE DRAWINGS

Various embodiments or examples (“examples”) of the present application are disclosed in the following detailed description and the accompanying drawings. The drawings are not necessarily to scale:

FIG. 1 depicts one example of a diagram for a content management system;

FIG. 2 depicts one example of a computer system; and

FIG. 3 depicts an example of a flow diagram for a content management system.

### DETAILED DESCRIPTION

Various embodiments or examples may be implemented in numerous ways, including as a system, a process, a method, an apparatus, a user interface, or a series of program instructions on a non-transitory computer readable medium such as a computer readable storage medium or a computer network where the program instructions are sent over optical, electronic, or wireless communication links. In general, operations of disclosed processes may be performed in an arbitrary order, unless otherwise provided in the claims.

A detailed description of one or more examples is provided below along with accompanying figures. The detailed description is provided in connection with such examples, but is not limited to any particular example. The scope is limited only by the claims and numerous alternatives, modifications, and equivalents are encompassed. Numerous specific details are set forth in the following description in order to provide a thorough understanding. These details are provided for the purpose of example and the described techniques may be practiced according to the claims without some or all of these specific details. For clarity, technical material that is known in the technical fields related to the examples has not been described in detail to avoid unnecessarily obscuring the description.

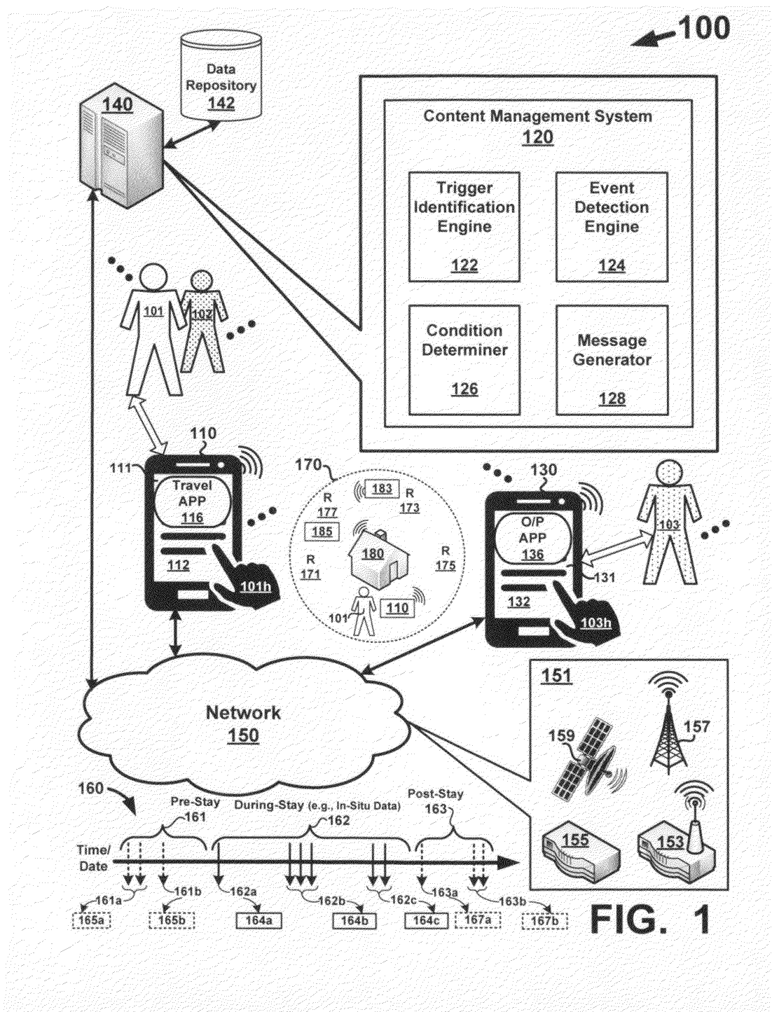

Reference is now made to FIG. 1 where one example of a diagram 100 for a content management system 120 is depicted. Content management system 120 may be implemented in hardware, software or both. Content management system 120 may include a trigger identification engine 122, an event detection engine 124, a condition determiner 126, and a message generator 128. Content management system 120 may be implemented on a one or more computing devices, such as a networked computing device 140 (server 140 hereinafter). Server 140 may be coupled with a data repository 142 (e.g., a data storage device, a memory, data base, etc.). Data repository may include a single data store or may include more than one data store, where different types of data are accessed from the different types of data stores. Content management system 120 may be configured to receive data and process data associated with a stay in a geographic region 170 associated with lodging 180 (e.g., a rental unit, a vacation rental unit, or other form of real property). Geographic region 170 may have any size and shape and is not limited to the circular example depicted in FIG. 1. Lodging 180 may be a hotel/motel room, a condo, a house, a townhouse or other form of accommodation. In geographic region 170 a traveler 110 (e.g., a user, guest, etc. who booked a stay at the lodging 180) may carry on their person a traveler computing device 110 (e.g., a smartphone, cellphone, tablet, pad, laptop, PDA, etc.). Traveler computing device 110 may generate data, access data, and process data associated with the stay at the lodging 180 via an application APP 116 (e.g., an application configured to execute on a processor of device 110). Traveler 101 may be accompanied by or may meet with an associate traveler 102 and associate traveler 102 may have a traveler computing device (not shown) similar to the type of device for traveler device 110, for example. Content management system 120 may access or otherwise communicate data to/from other computing devices, such as 110 and 113, for example. There may be more or fewer computing devices, travelers, associate travelers, and owner/proprietors than depicted in FIG. 1.

Within geographic region 170, traveler 101 may participate in one or more activities denoted as 183 and 185 and those activities may be located at different regions (e.g., locations) within the geographic region 170 as denoted by regions R 171-R 177. For example, activity 183 may be located at region R 173 and activity 185 may be located at region R 177. Regions R 171-R 177 and lodging 180 may be associated with location data (e.g., geolocation data for longitude and latitude). The location data may be used by device 110 and/or system 120 to calculate distance between two points, such as a distance between lodging 180 and an activity (e.g., 183) and/or or a region (e.g., R 177), to track or otherwise determine a location of traveler 101 relative to one or more of geographic region 170, lodging 180, an activity (e.g., 183, 185) or a region (e.g., R 171-R 177). The location data (e.g., geolocation data generated by device 110 and/or accessed from a data store) may be used to calculate rate of travel (e.g., miles/hour), an estimated time of arrival, or location of device 110 (e.g., a location of traveler 101 inferred from a location of the traveler's 101 computing device 110).

A stay by the traveler 101 at lodging 180 may be compartmentalized into three distinct stages or temporal periods (e.g., dates, times or both for the stay at lodging 180). A pre-stay period where the traveler 101 has not begun the travel to lodging 180, the traveler 101 is in transit to the lodging 180 but has yet to arrive at the lodging 180, and the traveler 101 has arrived in the geographic region 170 but has yet to check-in at the lodging 180, for example. A during-stay period where the traveler 101 has checked-in to the lodging 180 (e.g., traveler 101 has performed a check-in procedure and has gained access to lodging 180) and may be partaking of various activities at various regions within geographic region 170, for example. And a post-stay period where the traveler 101 has checked-out of the lodging (e.g., traveler 101 has performed a check-out procedure and has surrendered access to lodging 180), the traveler 101 has checked-out and is in transit from the geographic region 170, for example.

A diagram 160 depicts the various temporal periods along a time/date line, where the pre-stay period 161, the during-stay period 162 and the post-stay period 163 are positioned from left-to-right along the time/date line. Demarcations between the three different temporal periods may be determined by stay date data associated with the stay at lodging 180, such as a beginning stay date and/or time (e.g., a check-in time at 3:00 pm) and an ending stay date and/or time (e.g., a check-out time at 12:00 pm). Data representing the stay date data may be generated by content management system 120 or another system after traveler 101 has booked a stay (e.g., made a reservation) for the lodging 180.

Traveler device 110 and/or content management system 120 may generate one or more triggers during one or more of the temporal periods 161-163. For example, data representing one or more triggers 161a and 161b (denoted by dashed arrows) in pre-stay period 161, triggers 162a-162c in during-stay period 162 (e.g., generated in-situ), and triggers 163a-163b in post-stay period 163. The data representing the one or more triggers may be generated by traveler device 110, content management system 120, or both. For example, APP 116 may access systems of device 110 to generate triggers (e.g., a GPS system to generate triggers representing geolocation data).

Triggers generated during a temporal period (e.g., 161-163) may be correlated by traveler device 110, content management system 120, or both. For example, a single trigger 161b may be correlated with other data (e.g., an event in region 170) or multiple triggers, such as 161a, 162b, 162c and 163b may be correlated with other data. Multiple triggers may include different types of data such as data representing geolocation data, temporal data, event data, distance data, for example.

Correlation of the triggers with other data, such as event data may be used to determine an occurrence of one or more events during a temporal period, such as occurrence of event 165a and 165b in pre-stay period 161 as determined by a correlation of data from triggers 161a and 161b. Similarly, occurrence of events 164a, 164b, 164c, 167a and 167b may be determined as a result of correlation of their respective triggers.

Content management system 120, server 140, data repository 142, traveler device 110, an owner/proprietor device 113 (proprietor device hereinafter) may be in communication with a network 150 via wireless communication links (e.g., WiFi, WiMAX, Bluetooth, near field communications—NFC, cellular or other wireless protocols), wired communications links (e.g., local area network—LAN, Fire Wire, Ethernet, universal serial bus—USB or other wired protocols). Network 150 may include one or more communications resources 151, including but not limited to one or more WiFi access points 153 (e.g., a wireless router), wired access points 155 (e.g., a router), cellular communication networks 157, and communication satellites 159 (e.g., a GPS satellite).

Communications resources 151 may be configured to provide external geolocation data on traveler device 110 that may be used by device 110 and/or system 120 for determining distance, position, location, estimated time of arrival (ETA), rate of travel and other data that may be determined using geolocation data, such as longitude and latitude data. Distance and other geolocation-data based calculations (e.g., between device 110 and lodging 180 or device 110 and an activity) may be performed via an applications programming interface (API) call by device 110, system 120 or both.

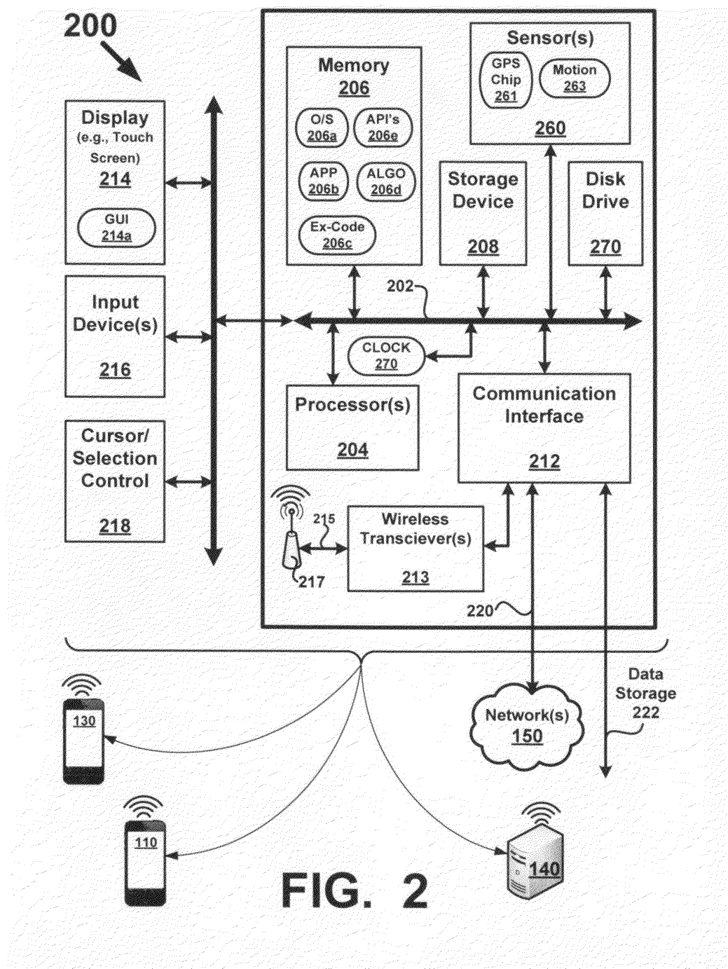

FIG. 2 illustrates an exemplary computer system 200 suitable for use in one or more systems, devices, compute engines, apparatus, traveler devices, owner devices, wireless devices, wireless systems, backend systems, front end systems, networked systems, platforms, data storage devices, data storage systems, external resources, host devices or others described in reference to FIG. 1. In some examples, computer system 200 may be used to implement computer programs, algorithms, an application (APP), an application programming interface (API), configurations, methods, processes, or other software to perform the above-described techniques. Computer system 200 may include circuitry, hardware, and other electronic systems to perform the above-described techniques. Computer system 200 may include a bus 202 or other communication mechanism for communicating information, which interconnects subsystems and devices, such as one or more processors 204 (e.g., μC, μP, DSP, ASIC, FPGA, Baseband, etc.), system memory 206 (e.g., RAM, SRAM, DRAM, Flash), storage device 208 (e.g., Flash, ROM), disk drive 270 (e.g., magnetic, optical, solid state), communication interface 212 (e.g., modem, Ethernet, WiFi, Cellular), display 214 (e.g., CRT, LCD, LED, OLED, touch screen), input device 216 (e.g., keyboard, stylus, touch screen, mouse, track pad), and cursor control 218 (e.g., mouse, trackball, stylus). Some of the elements depicted in computer system 200 may be optional, such as elements 214-218, and one or more clocks 270 which may provide temporal data, for example, one or more sensors 260 which may provide location data, rate of motion data and other data associated with movement (e.g., of traveler 101), and computer system 200 need not include all of the elements depicted. Display 214 may present a user interface (UI), such as a graphical user interface (GUI) 214a. Memory 206 may include computer executable programs and/or data embodied in a non-transitory computer readable medium, such as an operating system (OS) 206a, an application (APP) 206b, executable code (Ex-Code) 206c, algorithms (ALGO) 206d, one or more application programming interfaces (API) 206e, for example. As one example, API 206e may include instructions configured to access GPS data from a GPS system of device 110 (e.g., GPS chip 261) or for assisted GPS.

According to some examples, computer system 200 performs specific operations by one or more processors 204 executing one or more sequences of one or more instructions stored in system memory 206. Such instructions may be read into system memory 206 from another non-transitory computer readable medium, such as storage device 208 or disk drive 210 (e.g., a HDD or SSD). In some examples, circuitry may be used in place of or in combination with software instructions for implementation. The term “non-transitory computer readable medium” refers to any tangible medium that participates in providing instructions and/or data to processor(s) 204 for execution. Such a medium may take many forms, including but not limited to, non-volatile media and volatile media. Non-volatile media includes, for example, optical, magnetic, or solid state disks, such as disk drive 210. Volatile media includes dynamic memory, such as system memory 206. Common forms of non-transitory computer readable media includes, for example, floppy disk, flexible disk, hard disk, SSD, magnetic tape, any other magnetic medium, CD-ROM, DVD-ROM, Blu-Ray ROM, USB thumb drive, SD Card, any other optical medium, punch cards, paper tape, any other physical medium with patterns of holes, RAM, PROM, EPROM, FLASH-EPROM, any other memory chip or cartridge, or any other medium from which a computer may read.

Sensor(s) 260 may include but are not limited to one or more motion sensors 263 (e.g., an inertial sensor, an accelerometer, a multi-axis accelerometer, a gyroscope, a magnetometer, etc.), temperature sensor (e.g., ambient temperature), an altimeter, and a barometer, for example. One or more sensors in sensor(s) 260 may be used to determine location data for a device that includes computer system 200 and/or is in communication with computer system 200 (e.g., a client device, a traveler device, an owner/proprietor device, a smartphone, a merchant device, a tablet, a pad, a laptop, PC, a wireless device, a portal computing device, a computing device, a networked computing device, a platform, a backend service, etc.). One or more of the memory 206, storage device 208, or disk drive 210 may be accessed as a data store for location data from sensor(s) 260, GPS chip 261, or other systems in communication (e.g., via communications interface 212) the computer system 200. Location data may be communicated to/from the computer system 200 via one or more of the wireless transceivers 213.

For example, radio frequency signal sources including but not limited to GPS satellite signals (e.g., signals from one or more GPS satellites 134), terrestrial location transmitters (e.g., one or more cellular towers), WiFi signals, WiMAX signals, WiFi routers, WiFi access points, Bluetooth signals (e.g., Bluetooth beacons), near field communication signals, iBeacons, data from network 150, and content management system 120. Other signal and/or data sources for location data may include but are not limited to audio signals (e.g., ultrasonic signals) and signals and/or data generated by location tracking software (e.g., internal to and/or external to computer system 200), for example. In some examples, location data and/or signals may be communicated wireless communications link and/or a wired communications link. Location data accessed by computer system 200 may include but is not limited to a location history data base (e.g., stored in 142) and location data from other systems or devices (e.g., 155, 153, 157, 159), for example. The location data may be updated, revised or otherwise change on a dynamic basis as device 110 moves around in geographic region 170.

Instructions may further be transmitted or received using a transmission medium. The term “transmission medium” may include any tangible or intangible medium that is capable of storing, encoding or carrying instructions for execution by the machine, and includes digital or analog communications signals or other intangible medium to facilitate communication of such instructions. Transmission media may include coaxial cables, copper wire, and fiber optics, including wires that comprise bus 202 for transmitting a computer data signal or other signals (e.g., from hardware or circuitry). In some examples, execution of the sequences of instructions may be performed by a single computer system 200. According to some examples, two or more computer systems 200 coupled by communication link 220 (e.g., LAN, Ethernet, PSTN, USB, or wireless network) may perform the sequence of instructions in coordination with one another. Computer system 200 may transmit and receive messages, data, and instructions, including programs, (i.e., application code), through communication link 220 and communication interface 212. Communication link 220 may couple computer system 200 with one or more external networks 250, such as network 150 of FIG. 1, for example. Received program code may be executed by processor 204 as it is received, and/or stored in disk drive 210, or other non-volatile storage for later execution. Computer system 200 may optionally include a wireless transceiver 213 coupled with the communication interface 212 and coupled 215 with an antenna 217 for receiving and generating RF signals, such as from a WiFi network, WiMAX network, BT radio, Cellular network, networked computing resources, network 150, client devices (e.g., 110), owner/proprietor devices (e.g., 130), near field communication (NFC), satellite network, data storage network, or other wireless network and/or wireless devices, for example. Examples of wireless devices (e.g., traveler devices) may include but is not limited to those depicted in FIG. 1. Communications interface 212 may be coupled 222 with data storage external to computer system 200 (e.g., 142). Communications interface 212 may be coupled with external resources and/or systems. Computer system 200 may be used to implement a computing device (e.g., 110, 130), a portal computing device (e.g., 153, 155, 157, 159), a networked computing device (e.g., 140), and network 150, for example.

Processor(s) 204 may be coupled 202 with signals from circuitry or other hardware systems of computer system 200. For examples, signals from clock 270, sensors 260, and communications interface (e.g., via wireless transceivers 213) may be processed by processor 204 and/or other circuitry to calculate an estimated time of arrival of the device 110 (e.g., due to motion of traveler 101 carrying device 110) at an activity in a geographic location associated with a stay at rental 120, or other activities. The ETA may be calculated based on time data from clock 270 and one or more of location data (e.g., longitude and latitude coordinates), speed data (e.g., scalar data), or velocity data (e.g., vector data). Speed or velocity data may be calculated from signals from sensors 260, GPS chip 261, and changes in location data as traveler 101 and his/her associated device 110 move M relative to an activity (e.g., a restaurant) or other reference point (e.g., root coordinates of rental 120). Rate of travel (e.g., distance traveled per unit of time) may be calculated using signals from clock 270, sensors 260, GPS chip 261 and/or other location data.

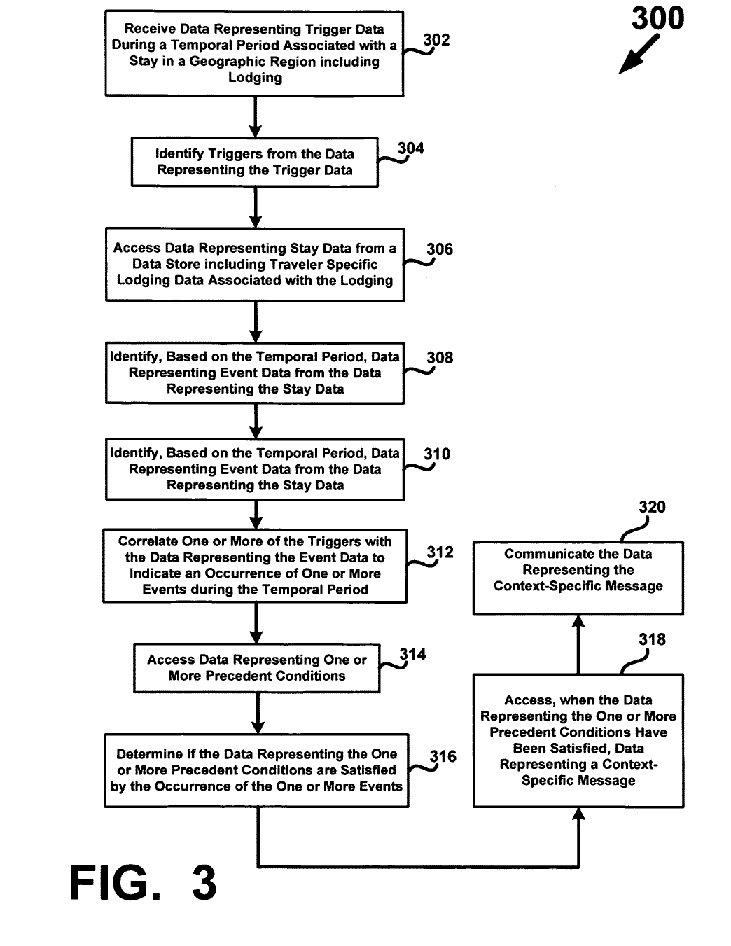

Reference is now made to FIG. 3 where an example of a flow diagram 300 for a content management system is depicted. At a stage 302 data representing trigger data during a temporal period (e.g., 161-163) associated with a stay in a geographic region (e.g., 170) that includes lodging (e.g., 180) is received (e.g., at content management system 120). At a stage 304 triggers from the data representing the trigger data may be identified. Identification may include determining a type of data associated with each trigger, such as geolocation data, temporal data, event data, etc. The data received may be in the form of a packet or other data structure that may include fields, headers or other structures that include information that describes a data payload. At a stage 306, data representing stay data (e.g., a stay date range, location of lodging, etc.) from a data store that includes traveler specific lodging data (e.g., specific to traveler 101) associated with the lodging may be accessed. At a stage 310, based on the temporal period (e.g., pre-stay, during-stay, post-stay), data representing event data from the data representing the stay data may be identified. Event data identified may include information on activities and location of activities in geographic region 170. At a stage 312 one or more of the triggers (e.g., depicted in 160 of FIG. 1) may be correlated with the data representing the event data to indicate an occurrence of one or more events (e.g., 165a, 164g, etc.) during the temporal period (e.g., 161-163). Correlation may include comparing trigger data representing geolocation data for a location of device 110 with trigger data representing geolocation data for an activity (e.g., dining at a restaurant) to indicate that traveler 101 was present at the event based on a coincidence between the geolocation data for the device 110 and the geolocation data for the activity (e.g., the restaurant). As another example, correlation may include calculating a distance of device 110 from lodging 180 to determine if the distance is within a threshold of an allowable distance from the lodging. The calculated distance may have a different context based on the temporal period the distance is calculated in. For example, if the threshold is 15 meters and the calculate distance is less than or equal to 15 meters, and the temporal period is the during-stay period, then the correlation that may be indicated is that the traveler 101 (e.g., via location of device 110) is about to check-in or has already checked-in to the lodging associated with a reservation booked by the traveler 101. A context specific message may be communicated to device 110 and may include contextually relevant information, such as a check-in procedure, an access code (e.g., for a door lock) or other form of access credentials, such as WiFi access credentials, for example. As another example, if the threshold is 15 meters and the calculate distance is 150 kilometers, and the temporal period is the pre-stay period, then the correlation that may be indicated is that the traveler 101 is not yet in the geographic region 170 and may be in route (e.g., traveling to) the geographic region 170. Another context specific message may be communicated to device 110 and may include contextually relevant information, such as driving directions to lodging 180, for example.

At a stage 314, data representing one or more precedent conditions may be accessed. The one or more precedent conditions may originate from data communicated by proprietor device 130 (e.g., from an owner of lodging 180 or a proprietor of an activity such as a restaurant). A precedent condition may be generated by system 120 or may be a pre-stored precedent condition associated with an event, activity or other data associated with geographic region 170 and/or lodging 180. At a stage 316 a determination may be made as to whether or not the data representing the one or more precedent conditions are satisfied by the occurrence of the one or more events. As one example, one of the precedent conditions may be that access credentials for lodging 180 may not be communicated until: (a) traveler 101 is within the threshold of the allowable distance; (b) condition (a) occurs during the during-stay period 162; and (c) traveler 101 has completed a check-in procedure for the lodging 180 (e.g., signed in at the front desk). The one or more precedent conditions may be application dependent, may be configured to fit a variety of situations, and are not limited by the examples described herein.

At a stage 318, when the data representing the one or more precedent conditions have been satisfied, data representing a context-specific message may be accessed (e.g., from a message data store). At a stage 320, the data representing the context-specific message may be communicated (e.g., to the traveler device 110). In some examples, the data representing the one or more precedent conditions, the data representing the context-specific message or both may originate (e.g., be transmitted from) the proprietor device 130.

Flow 300 may be implemented using hardware, software or both. The various stages of flow 300 need not be executed in the order depicted in FIG. 3 and there may be variations and/or additions to the stages depicted.

For example, one or more stage in flow 300 may include receiving data representing trigger data originating from a traveler computing device (e.g., 110) during a temporal period associated with a stay in the geographic region that includes the lodging 180, identifying triggers from the data representing the trigger data, accessing data representing stay data originating from a memory storing traveler specific lodging data (e.g., 142) associated with the lodging 180, identifying based on the temporal period, data representing event data from the data representing the stay data, correlating one or more of the triggers with the data representing the event data to indicate an occurrence of one or more events during the temporal period (e.g., check-in, check-out, distance between device 110 and an activity, etc.), accessing data representing one or more precedent conditions (e.g., temporal data indicates the during-stay period 162, location data indicates device 110 is within the threshold of the allowable distance, etc.), determining if the data representing the one or more precedent conditions are satisfied by the occurrence of the one or more events, accessing, when the data representing the one or more precedent conditions have been satisfied, data representing a context-specific message, and communicating (e.g., wirelessly) the data representing the context-specific message to the traveler computing device 110, for example.

Flow 300 may include other stages, such as stages that identify data representing temporal data from at least one of the triggers and compare the data representing the temporal data with stay date data (e.g., check-in/check-out times and/or dates) extracted from the data representing the stay data to indicate that the temporal period coincides with the pre-stay temporal period 161, the during-stay temporal period 162 or the post-stay temporal period 163, for example.

Flow 300 may identify, from at least one of the triggers, data representing location data that indicates a geolocation of the traveler computing device 110 during the pre-stay temporal period 161, calculate (e.g., using a call to an API) a distance between the geolocation (e.g., longitude and latitude) of the traveler computing device 110 and another geolocation of the lodging 180 (e.g., a known longitude and latitude for 180 accessed from 142), for example. The data representing the pre-stay context-specific message may include travel directions to the lodging 170 or other form of directions, such as a map, turn-by-turn directions, etc. As another example, flow 300 may access, when the distance is within the threshold of the allowable distance (e.g., 10 meters) for the lodging 180, the data representing the pre-stay context-specific message (e.g., information for a check-in procedure for the lodging 170).

Similar to the above example, flow 300 generate context-specific messages for other temporal periods, such as the during-stay period 162 (e.g., access credentials for the lodging 170) and/or post stay period 163 (e.g., travel direction from the lodging 170 to traveler's 101 home).

Flow 300 may include, identifying, from at least one of the triggers, data representing location data that indicates a geolocation of the traveler computing device during the during-stay temporal period, calculating a distance between the geolocation of the traveler computing device and the geolocation of the lodging, determining, based on the calculating, if the distance is within a threshold of an allowable distance from the geolocation of the lodging, accessing, when the distance is within the threshold, data representing a during-stay context-specific message, and communicating the data representing the during-stay context-specific message to the traveler computing device 110, for example. The data representing the during-stay context-specific message may include access credentials (e.g., a lock code) for access to the lodging 170.

Flow 300 may include identifying data representing temporal data from at least one of the triggers, comparing the temporal data with stay date data extracted from the data representing the stay data to indicate that the temporal period coincides with a during-stay temporal period, identifying, from at least one of the triggers, data representing location data that indicates a geolocation of the traveler computing device during the during-stay temporal period, identifying, from at least one of the triggers, data representing an advisory condition in the geographic region, calculating a distance between the geolocation of the traveler computing device and another geolocation of the lodging, determining, based on the calculating, if the distance is within a threshold of an allowable distance from the another geolocation, accessing, when the distance is within the threshold of the allowable distance, the data representing an advisory context-specific message, and communicating the data representing the advisory context-specific message to the traveler computing device 110, for example. The data representing the advisory context-specific message may include health, safety or welfare advisory information associated with the advisory condition (e.g., tainted water, a gas line leak, tornado warning, etc.). The data representing the advisory context-specific message may include traffic advisory information associated with the advisory condition (e.g., a road closure, traffic jam, traffic detour, etc. The data representing the advisory context-specific message may include weather advisory information associated with the advisory condition (e.g., rain, snow, high temperatures, low temperatures, etc.).

Flow 300 may include identifying data representing temporal data from at least one of the triggers, comparing the temporal data with stay date data extracted from the data representing the stay data to indicate that the temporal period coincides with a during-stay temporal period, identifying, from at least one of the triggers, data representing location data that indicates a geolocation of the traveler computing device during the during-stay temporal period, identifying, from at least one of the triggers, data representing an event in the geographic region, identifying, from at least one of the triggers, data representing a geolocation for the event in the geographic region, identifying, from at least one of the triggers, data representing a notification relevant to the event in the geographic region, and calculating (e.g., via an API call), using the geolocation of the traveler computing device and the geolocation of the event, a distance between the traveler computing device and the event. Data representing a notification context-specific message may be accessed and may include a notice of an alternative event located in the geographic region, and the data representing the notification context-specific message (e.g., a change from an outdoor activity to an indoor activity) may be communicated (e.g., wirelessly) to the traveler computing device 110. The data representing the notification relevant to the event in the geographic region may include a notice of a change in weather at the geolocation for the event in the geographic region. The data representing the notification relevant to the event in the geographic region comprises notice of a cancellation of the event. The data representing the notification context-specific message may be communicated to the traveler computing device before the distance from the calculating indicates that the traveler computing device is present at the event (e.g., save the traveler 101 time by diverting the traveler to an alternative event).

Flow 300 may include identifying, from at least one of the triggers, data representing a selection action originating from the traveler computing device, accessing data representing activity data originating from a memory storing activity specific data associated with the geographic region for the lodging, comparing the data representing the selection action with the data representing activity data to indicate a match with one or more activities located in the geographic region for the lodging, accessing, when the match is indicated, data representing an activity context-specific message, the data representing the activity context-specific message comprises an activity and a location of the activity in the geographic region, and communicating the data representing the activity context-specific message to the traveler computing device 110. The data representing the selection action may include a click-through action originating from the traveler computing device 110 (e.g., activation 101h of information 112 presented on a touch-screen 111 of device 110). The data representing the activity context-specific message may originate from the proprietor computing device 130 (e.g., activation 103h of an activity context-specific message 132 presented on a touch-screen 131 of device 130).

Although the foregoing examples have been described in some detail for purposes of clarity of understanding, the above-described conceptual techniques are not limited to the details provided. There are many alternative ways of implementing the above-described conceptual techniques. The disclosed examples are illustrative and not restrictive.

What is claimed is:

1. A method, comprising:
receiving data representing trigger data originating from a traveler computing device during a temporal period associated with a stay in a geographic region including lodging;
identifying triggers from the data representing the trigger data;
accessing data representing stay data originating from a memory storing traveler specific lodging data associated with the lodging;
identifying, based on the temporal period, data representing event data from the data representing the stay data;
correlating one or more of the triggers with the data representing the event data to indicate an occurrence of one or more events during the temporal period;
accessing data representing one or more precedent conditions;
determining if the data representing the one or more precedent conditions are satisfied by the occurrence of the one or more events;
accessing, when the data representing the one or more precedent conditions have been satisfied, data representing a context-specific message; and
communicating the data representing the context-specific message to the traveler computing device.

2. The method of claim 1, wherein the receiving further comprises the data representing the one or more precedent conditions, the data representing the context-specific message or both originating from a proprietor computing device.

3. The method of claim 1 and further comprising:
identifying data representing temporal data from at least one of the triggers; and
comparing the data representing the temporal data with stay date data extracted from the data representing the stay data to indicate that the temporal period coincides with a pre-stay temporal period, a during-stay temporal period or a post-stay temporal period.

4. The method of claim 3 and further comprising:
identifying, from at least one of the triggers, data representing location data that indicates a geolocation of the traveler computing device during the pre-stay temporal period;
calculating a distance between the geolocation of the traveler computing device and another geolocation of the lodging;
determining, based on the calculating, if the distance is within a threshold of an allowable distance from the another geolocation;
accessing, when the distance is not within the threshold of the allowable distance, data representing a pre-stay context-specific message; and
communicating the data representing the pre-stay context-specific message to the traveler computing device.

5. The method of claim 4, wherein the data representing the pre-stay context-specific message comprises travel directions to the lodging.

6. The method of claim 4 and further comprising:
accessing, when the distance is within the threshold of the allowable distance, the data representing the pre-stay context-specific message,
wherein the data representing the pre-stay context-specific message comprises information for a check-in procedure for the lodging.

7. The method of claim 3 and further comprising:
identifying, from at least one of the triggers, data representing location data that indicates a geolocation of the traveler computing device during the during-stay temporal period;
calculating a distance between the geolocation of the traveler computing device and another geolocation of the lodging;
determining, based on the calculating, if the distance is within a threshold of an allowable distance from the another geolocation;
accessing, when the distance is within the threshold, data representing a during-stay context-specific message; and
communicating the data representing the during-stay context-specific message to the traveler computing device.

8. The method of claim 7, wherein the data representing the during-stay context-specific message comprises access credentials for the lodging.

9. The method of claim 1 and further comprising:
identifying data representing temporal data from at least one of the triggers;
comparing the temporal data with stay date data extracted from the data representing the stay data to indicate that the temporal period coincides with a during-stay temporal period;
identifying, from at least one of the triggers, data representing location data that indicates a geolocation of the traveler computing device during the during-stay temporal period;
identifying, from at least one of the triggers, data representing an advisory condition in the geographic region;
calculating a distance between the geolocation of the traveler computing device and another geolocation of the lodging;
determining, based on the calculating, if the distance is within a threshold of an allowable distance from the another geolocation;
accessing, when the distance is within the threshold of the allowable distance, the data representing an advisory context-specific message; and
communicating the data representing the advisory context-specific message to the traveler computing device.

10. The method of claim 9, wherein the data representing the advisory context-specific message comprises health, safety or welfare advisory information associated with the advisory condition.

11. The method of claim 9, wherein the data representing the advisory context-specific message comprises traffic advisory information associated with the advisory condition.

12. The method of claim 9, wherein the data representing the advisory context-specific message comprises weather advisory information associated with the advisory condition.

13. The method of claim 1 and further comprising:
identifying data representing temporal data from at least one of the triggers;
comparing the temporal data with stay date data extracted from the data representing the stay data to indicate that the temporal period coincides with a during-stay temporal period;
identifying, from at least one of the triggers, data representing location data that indicates a geolocation of the traveler computing device during the during-stay temporal period;
identifying, from at least one of the triggers, data representing an event in the geographic region;
identifying, from at least one of the triggers, data representing a geolocation for the event in the geographic region;
identifying, from at least one of the triggers, data representing a notification relevant to the event in the geographic region; and
calculating, using the geolocation of the traveler computing device and the geolocation of the event, a distance between the traveler computing device and the event.

14. The method of claim 13 and further comprising:
accessing data representing a notification context-specific message, the data representing the notification context-specific message comprises a notice of an alternative event located in the geographic region; and
communicating the data representing the notification context-specific message to the traveler computing device.

15. The method of claim 14, wherein the data representing the notification relevant to the event in the geographic region comprises notice of a change in weather at the geolocation for the event in the geographic region.

16. The method of claim 14, wherein the data representing the notification relevant to the event in the geographic region comprises notice of a cancellation of the event.

17. The method of claim 14 and further comprising:
communicating the data representing the notification context-specific message to the traveler computing device before the distance from the calculating indicates that the traveler computing device is present at the event.

18. The method of claim 1 and further comprising:
identifying, from at least one of the triggers, data representing a selection action originating from the traveler computing device;
accessing data representing activity data originating from a memory storing activity specific data associated with the geographic region for the lodging;
comparing the data representing the selection action with the data representing activity data to indicate a match with one or more activities located in the geographic region for the lodging;
accessing, when the match is indicated, data representing an activity context-specific message, the data representing the activity context-specific message comprises an activity and a location of the activity in the geographic region; and
communicating the data representing the activity context-specific message to the traveler computing device.

19. The method of claim 18, wherein the data representing the selection action comprises a click-through action originating from the traveler computing device.

20. The method of claim 18, wherein the data representing the activity context-specific message originates from a proprietor computing device.
